(19) United States
(12) Patent Application Publication
(10) Pub. No.: US 2015/0025145 A1
(43) Pub. Date: Jan. 22, 2015

(54) ANTIMICROBIAL COMPOSITION CONTAINING LAURIC ACID AND METHODS FOR THEIR PRODUCTION

(71) Applicant: Cargill, Incorporated, Wayzata, MN (US)

(72) Inventors: Frank Hollander, Ochten (NL); Marcus Bernardus Kruidenberg, Oostvoome (NL); Henricus Wilhelmus Jozef Lobee, Zuilichem (NL); Evelien Van Der Hoeven-Hangoo, Leerdam (NL)

(73) Assignee: Cargill, Incorporated, Wayzata, MN (US)

(21) Appl. No.: 14/383,245

(22) PCT Filed: Mar. 7, 2013
(86) PCT No.: PCT/IB13/00629

§ 371 Date: Sep. 5, 2014

(30) Foreign Application Priority Data
Mar. 7, 2012 (EP) 12001554.0

(51) Int. Cl. A01N 37/02; A23K 1/17; A23K 1/16; C11C 1/04

(52) U.S. Cl. CPC A01N 37/02; C11C 1/04; A23K 1/17; A23K 1/164
USPC 514/558; 435/134; 426/532

(57) ABSTRACT

The present invention relates to the method of producing an antimicrobial composition characterized in that it comprises the steps of: a) splitting a lauric oil treated with activated carbon; and b) recovering a composition comprising 90% or more, by weight of free fatty acids. The invention further relates to antimicrobial compositions obtained by said process, to feed, food or beverage comprising said composition and to their uses.

### TECHNICAL FIELD

The present invention relates to antimicrobial oil compositions and to compositions for improving feed efficiency. In particular, it relates to compositions which can be used to prevent the growth of microbial agents in animals and improve feed efficiency, and to methods of producing such compositions.

### BACKGROUND OF THE INVENTION

Medium-chain fatty acids (MCFAs), i.e. fatty acids with a carbon chain length from 6-12 carbon atoms, are considered to be a unique category of fat substances. Unlike long-chain fatty acids, MCFAs can be absorbed directly into the bloodstream without re-esterification or inclusion in chylomicrons. As such, MCFAs can be transported rapidly to organs requiring energy. What's more, MCFAs are preferentially oxidized in the mitochondria, making them an excellent source of fast energy.

Certain MCFAs have also been found to have a beneficial antimicrobial effect. This is considered a key attribute in the field of animal husbandry where controlling levels of micro-organisms in the animals' digestive tract is a priority. Animals may be subject to exposure to bacteria, yeast and fungi through the rearing environment and feed products. These micro-organisms can cause significant disruption to the animals' digestive system and an imbalance in the microbial ecosystem of their gastrointestinal tract. This can result in less efficient digestion and nutrient absorption which, in turn, will affect growth rates. It could also lead, in some cases, to disease and, potentially, to the loss of the animal. In any event, it is clear that being able to control microbial populations has a significant effect on profitability. This used to be achieved through the application of low-dose antibiotics. However, the addition of such growth promoters to feed products was banned, in the EU, in 2006. Interest in natural alternatives—such as MCFAs—has therefore increased.

Lauric oils, such as coconut oil and palm kernel oil, are known to be rich in MCFAs. Unfortunately, triglycerides containing these fatty acids do not have the observed antimicrobial activity themselves. The MCFAs have to be separated from their glycerol backbone and used in their free fatty acid (FFA) form. This is achieved, in the industry, by splitting crude lauric oils and then distilling the oil to obtain a FFA fraction and a glycerine fraction.

There are at least four known methods of fat splitting: the Twitchell process (although somewhat archaic now), the batch autoclave process, the continuous countercurrent process, and the enzymatic process (using lipase enzymes). The fatty acids produced by these processes are then purified and separated into fractions by distillation and fractionation.

Because of the extreme sensitivity of fatty acids to heat, oxidation and corrosion effects, distillation must be performed under highly controlled conditions—i.e. under high vacuum, at lower temperatures and with the shortest possible residence time. Nonetheless, fatty acid distillates tend to develop a strong taste and smell (caused by secondary oxidation products such as ketones and aldehydes). They can also have a strong degree of coloration due to the presence of pigments such as carotenoids. This process may also result in concentrations of contaminants (such as dioxins and poly aromatic hydrocarbons (PAHs)) which are very difficult to remove.

Nonetheless, these distillates have been considered generally acceptable for animal feed. There is, however, increasing concern over contaminant levels. What's more, their strong odor and taste has always made them unsuitable for use in certain animal feeds: aquatic feed (e.g. for fish and shrimp), feed for young animals (e.g. veal calves and piglets), and domestic animal food all require the use of less strong-tasting and -smelling oils.

There is therefore a clear need in the art for a new “natural” antimicrobial agent with better or less taste, smell and color and with a reduced contaminant content—and for a process for producing such products. The present invention addresses this need.

### STATEMENTS OF THE INVENTION

According to a first aspect of the present invention, there is provided a method of producing an antimicrobial composition, characterized in that it comprises the steps of: (A) splitting an activated carbon treated lauric oil; and (B) recovering a composition comprising 90% or more, by weight, free fatty acids. Preferably, step (A) will comprise: (a) bringing a lauric oil into contact with activated carbon to obtain an activated carbon treated oil; and (b) splitting the activated carbon treated oil.

According to a further aspect of the present invention, there is provided an antimicrobial composition obtainable according to the above method. Preferably, said composition will comprise 90% or more, by weight, free fatty acids (FFAs), and will have: a Lovibond red colour of 5 or less; and/or an acceptable taste and smell as determined by Method A (set out below); and/or a total PAH level of 20 TEQ B[a]P or less; and/or a total dioxin content no greater than 1.5 TEQ.

According to another aspect of the present invention, there is provided an antimicrobial composition as defined above for use in preventing the growth of microbial agents and/or for improving gastro-intestinal health in animals; and/or for use in increasing feed efficiency, and/or for use in enhancing growth and/or reducing mortality in animals.

According to a yet further aspect of the present invention, there is provided a feed, food or beverage composition comprising the antimicrobial composition defined above, preferably in an amount of 0.05-10% by weight, based on total weight of the feed, food or beverage composition.

### DESCRIPTION OF INVENTION

The present invention provides a method of producing antimicrobial compositions. The term “antimicrobial” as used herein refers to substances that are capable of killing or inhibiting the growth of microorganisms such as bacteria and fungi (including yeasts). In particular, it may refer to substances that are capable of killing or inhibiting the growth of fungi such as Aspergillus, Candida, Cephalosporum, Fusarium, and Penicillium; yeasts such as Saccharomyces; Gram-negative bacteria such as Escherichia coli, Salmonella, and Shigella; and Gram-positive bacteria such as Listeria.

The process of the present invention includes the step of splitting an activated carbon treated lauric oil to obtain a composition comprising 90% or more, by weight, free fatty acids. Lauric oils will generally be understood to be oils rich in MCFAs, as defined below (i.e. comprising at least 40%, preferably at least 50%, more preferably at least 60% MCFAs by weight). Examples of such oils include coconut oil, palm kernel oil, babassu oil, cohune oil, tacum oil and cuphea oil, together with any fractions (especially olein fractions) or derivatives (obtained, e.g. by full or partial hydrogenation) thereof. For the purposes of the present invention, the lauric oil will preferably a coconut oil or coconut olein fraction, a palm kernel oil or palm kernel olein fraction, or mixtures of two or more thereof.

Activated carbon treatment may be performed with powdered, granular, extruded or bead activated carbon—or with any other known form of activated carbon. The treatment may be performed in a continuous or batch process. Preferably, it will be performed in a column with granular activated carbon. The oil will preferably be brought into contact with the activated carbon at a temperature of 50-120° C., preferably of 50-90° C., more preferably of 50-75° C. For example, the oil may be brought into contact with the activated carbon at a temperature of about 60° C. The activated carbon may be used, for instance, in an amount of 10 g per MT of oil to 50 kg per MT of oil, preferably in an amount of 100 g per MT of oil to 25 kg per MT of oil, more preferably in an amount of 500 g per MT of oil to 10 kg per MT of oil, more preferably in an amount of 750 g per MT of oil to 5 kg per MT of oil. According to one aspect of the invention, it will be used in an amount of 1-2 kg per MT of oil. Other parameters and variations thereof will be apparent to a person skilled in the art.

The lauric oils used in the process of the present invention may be pre-treated with activated carbon or the process may itself include a step of bringing the oils into contact with activated carbon to obtain an activated carbon treated lauric oil.

Activated carbon treatment may be used on its own or, alternatively, it may be used in combination with one or more refining steps. Indeed, although certain crude lauric oils (such as some sun-dried coconut oil from the Fuji Islands) have very low contaminant levels and can thus be used as such in the method of the present invention, most crude oils (i.e. oils as extracted from their original source) will preferably be refined. These oils have high levels of contaminants —such as phosphatides, soaps and pigments—which may cause an undesirable colour, odor or taste. These oils may be refined before use in the process of the present invention or the process may itself include one or more refining steps.

Refining typically consists of three major processes: degumming, bleaching and deodorization, all of which are well known processes to a person skilled in the art. According to one aspect of the present invention, the lauric oils used in the present invention will have been subjected to one or more of (and preferably all of) degumming, bleaching and deodorization. Alternatively, the process of the present invention may itself include one or more of (and preferably all of) these steps. Each of the steps may be performed separately or, alternatively, treatment with activated carbon may be performed simultaneously with the bleaching step (e.g. by combining the activated carbon and a bleaching earth together in a single column).Other refining steps may also be used as will be apparent to a skilled person.

For ease of reference, an oil which has been brought into contact with activated carbon, whether or not it has been subjected to one or more additional refining steps, will simply be referred to herein as an “activated carbon treated oil”.

According to the present method, activated carbon treated lauric oil is split such that a composition comprising 90% or more, by weight, free fatty acids is obtained. Unexpectedly, it has been observed that the treatment with activated carbon must be performed prior to the splitting step. Splitting, as described above, is a process for separating fatty acids from their glycerol backbone. A number of splitting techniques are known in the art and do not all need to be described in great detail here. For instance, the splitting technique used in the method of the present invention may encompass chemical hydrolysis and/or enzymatic splitting. By way of illustration only, chemical hydrolysis may be performed in a batch process (e.g. in a batch autoclave process) or in continuous process (also known as the Colgate-Emery process). Enzymatic splitting will preferably be performed with lipase enzymes such as fungal lipase enzymes, e.g. from the Candida, Aspergillus or Rhizopus genera. Specific examples of suitable lipase enzymes are those from Candida Rugosa, Aspergillus niger or Rhizopus arrhizus.

Preferably, splitting will be achieved through chemical hydrolysis under high pressure and at high temperatures. According to one possible embodiment, the split oil may be further subjected to one or more additional steps including, but not limited to, distillation, fractionation and/or purification. Advantageously, however, even without such additional steps, the compositions obtained by the process of the present invention will have a FFA content of at least 90% by weight, as determined according to AOCS method Ca 5a-40 (using the average molecular weight of lauric acid). What's more, they will preferably have an appropriate profile for use as a natural antimicrobial agent in the manufacture of feed, food and beverage compositions.

Thus, the present invention also relates to compositions obtainable by the methods described above. In particular, the present invention relates to refined antimicrobial compositions comprising 90% or more, by weight, FFAs.

As mentioned above FFA content is measured using the standard method AOCS Ca 5a-40 (using average molecular weight of lauric acid). Preferably, the compositions recovered from the process of the present invention will comprise 95% or more, more preferably 97% or more, more preferably 99% or more FFA by weight. The FFAs will have a high MCFA content. Preferably, they will comprise more than 50% MCFAs. More preferably, they will comprise 60% or more, 70% or more, or 80% or more MCFAs.

The term “MCFA” as used herein will be understood, in the context of the present invention, as referring to fatty acids with a carbon chain length from 6-12 carbon atoms (i.e. caproic acid (C6), caprylic acid (C8), capric acid (C10) and lauric acid (C12)), as well as to salts, emulsions and the like, together with mixtures thereof. According to one possible embodiment, the composition of the present invention will comprise, by weight:
0-5%, preferably 0-1%, C6 fatty acids;
1-15% , preferably 2-10%, C8 fatty acids;
1-15%, preferably 1-8%, C10 fatty acids; and
35-70%, preferably 40-55%, C12 fatty acids.

They will advantageously have less color, a better taste and/or smell, and/or fewer contaminants (that is to say a lower concentration of contaminants) than similar antimicrobial compositions obtained by distillation alone. In particular, the compositions of the present invention will preferably have:
a Lovibond red colour of 5 or less; and/or
an acceptable taste and smell as determined by Method A; and/or
a total PAH content of 20 TEQ B[a]P or less; and/or
a total dioxin content no greater than 1.5 TEQ.

Ideally, they will have a Lovibond red colour of 5 or less; and an acceptable taste and smell as determined by Method A; and a total PAH level of 20 TEQ B[a]P or less; and a total dioxin content no greater than 1.5 TEQ.

Lovibond red colour is measured on the Lovibond colour scale in accordance with AOCS method Cc13e. Red color is graded on a scale of 0.1 to 20. Preferably, compositions obtained according to the method of the present invention will have a Lovibond Red colour of 5 or less, more preferably of 2 or less, more preferably of 1 or less, for example of 0.5 or less. Ideally, the compositions will be white (when in their solid state).

The antimicrobial composition of the present invention will also preferably be devoid of any burnt taste or smell (which is often associated with e.g. coconut oil due to the processes used to dry the source materials). Taste and odor are assessed according to Method A: AOCS Method Cg 2-83. According to this method, oils are given a score from 1 to 10, wherein 1 indicates an oil with a very strong taste and/or odor, and 10 indicates a tasteless, odorless oil. Compositions will be considered as having an acceptable taste and odor according to the present invention if, when measured according to Method A, they have a score of 7 or more. Preferably, the compositions of the invention will be characterized by a score of 8 or more.

Advantageously, the compositions of the present invention will also have very low levels of contaminants. In particular, they will preferably have reduced levels of polycyclic aromatic hydrocarbons (PAHs) and of dioxins and dioxin-like compounds (DLCs) compared to corresponding oils obtained by distillation and fractionation. For ease of reference, dioxins and DLCs will commonly be referred to herein simply as dioxins.

As toxic compounds all have a different toxic effects, toxicity is typically measured in terms of toxicity equivalence (TEQ). TEQ is calculated as the product of the concentration of an individual toxic compound in a sample (in μg/kg) and its corresponding toxicity equivalency factor (TEF), i.e. as follows:

TEQ of compound A=concentration of A×TEF of A

The TEF of a compound is expressed as a number, between 0 and 1, which represents the compound's relative toxicity compared to that of the most toxic known compound in that category of compounds. Thus, for instance, the TEFs for PAHs are calculated relative to the toxicity of benzo[a]pyrene (B[a]P)—and the PAH content of a composition will therefore be expressed in terms of TEQ B[a]P. The TEFs of dioxins are calculated relative to the toxicity of 2,3,7,8-tetrachlorodibenzodioxin (TCDD)—with the dioxin content of a composition conventionally being expressed simply in terms of “TEQ”.

The toxicity of a composition—i.e. its total toxicity equivalence—will depend, to a certain extent, on the number of PAHs or dioxins being measured. Regulatory guidelines and food and feed law in different countries will often dictate the number of compounds that must be taken into account when assessing a product's toxicity. For instance, the composition of the present invention will preferably have a total PAH content of no more than 20 TEQ B[a]P, wherein this total TEQ value corresponds to the sum of TEQs for four specific PAHs, namely benzo[a]pyrene, benzo[a]anthracene, benzo[b]fluoranthene and chrysene (this is referred to as the 4-PAH method). In particular, when the antimicrobial composition of the present invention is produced from coconut oil, the total PAH content will preferably be no higher than 20 TEQ B[a]P. If it is produced from palm kernel oil, it will preferably be no higher than 10 TEQ B[a]P. Preferably, the composition of the present invention with have a total PAH content of no more than 10, more preferably no more than 4, more preferably no more than 1 TEQ B[a]P. In addition, the composition of the present invention will preferably have a B[a]P content of no more than 2, more preferably no more than 1 TEQ.

The total dioxin content of the compositions of the present invention will preferably be no more than 1.5, more preferably no more than 1 TEQ, more preferably no more than 0.75 TEQ—corresponding to the sum of TEQs for polychlorinated biphenyls (PCB), polychlorinated dibenzo-p-dioxins (PCDD) and polychlorinated dibenzofurans (PCDF). Furthermore, the composition of the invention will preferably have a PCB level no higher than 0.75, more preferably no higher than 0.5 TEQ, and a PCDD+PCDF level preferably no higher than 0.75, more preferably no higher than 0.5 TEQ.

The compositions of the present invention are suitable for use in food, feed and beverage compositions. In particular, they are suitable for use as antimicrobial agents for animal feed compositions and, in fact, animal feed compositions comprising such antimicrobial compositions are also part of the present invention.

The term “animal feed composition” as used herein, includes all solid or semi-solid feed compositions as well as liquid feed compositions and pre-mixes. It covers both agricultural feeds and pet foods. The animal feed composition will be admixed with the antimicrobial composition of the present invention to form an animal feed composition which, when administered, will provide an effective amount of the antimicrobial composition to the animal.

According to one particular embodiment, the present invention relates to feed compositions comprising the above antimicrobial compositions in an amount of 0.05 to 10% by weight, preferably in an amount of 0.2 to 5% by weight, even more preferably in an amount of 0.3 to 2% by weight, for example in an amount of 0.5 to 1% by weight, based on the total weight of the final feed.

In addition to the antimicrobial composition, the animal feeds of the present invention may further comprise one or more other active ingredients. These may include any material which can be added to the feed to enhance the animal's health, performance, and/or well-being. Examples of such ingredients are referred to in “2006 Feed Additive Compendium” and “Handbook of Feed Additives 2006”.

Feed compositions of the present invention may be used, for instance, for equine animals (such as horses), ovine animals (such as lamb and sheep) and bovine animals (such as cattle), but will be particularly suitable for calves (e.g. veal calves), porcine animals (such as pigs and piglets), rabbits, poultry (such as chickens, turkeys, ducks, pheasant and quail), domestic animals (such as cats and dogs), and aquatic animals (such as fish and shrimp).

The antimicrobial compositions of the present invention, and animal feed compositions comprising them, may be used to enhance feed efficiency and/or enhance growth and/or reduce mortality in animals. Thus, the present invention further provides a method of enhancing feed efficiency and/or enhancing growth and/or reducing mortality in an animal comprising providing to said animal for an effective time an effective amount of the antimicrobial composition of the present invention.

Feed efficiency is a term generally known in the art and refers to a ratio of weight of food ingested/weight gain of an animal (F:G). Enhancement of feed efficiency is an overall decrease in this F:G ratio over that which would otherwise occur without implementation of the methods and/or administration of the compositions of the present invention.

Growth and enhancing growth are terms generally known in the art and refer to increases in either, or both, weight and size (e.g., height, width, diameter, circumference, etc.) over that which would otherwise occur without implementation of the methods and/or administration of the compositions of the present invention. Growth can refer to an increase in the mass (e.g., weight or size) of the entire animal or of a particular tissue (e.g., muscle tissue in general or a specific muscle). Alternatively, growth can indicate a relative increase in the mass of one tissue in relation to another, in particular, an increase in muscle tissue relative to other tissues (e.g., adipose tissue).

Reducing mortality refers to increasing the survivability or decreasing the death rate in animals after birth or hatch as compared with that which would otherwise occur in the absence of implementation of the methods and/or administration of the compositions of the present invention.

Effective amount refers to the amounts of administration of the antimicrobial composition, to provide enhanced growth, enhanced feed efficiency, and/or reduced mortality. Further, such amounts and rates should result in no or few adverse events in the treated animal. As those familiar with the art will understand, the amounts and rates will vary depending upon a number of factors. These factors include, for example, the type of animal being treated, its weight and general physical condition, and the dosing regimen. Ranges for the rate of administration of the antimicrobial composition are from about 1 to about 3000, desirably 10 to 1000, and more desirably from about 10 to about 500 mg/kg of weight of the animal. These amounts are to be administered normally every day for at least 7 days, at least 2 weeks, at least 30 days, over 60 days, over 100 days, or for all or a substantial portion of the life of the animal.

The term “food composition” as used herein, will include all food products suitable for consumption by humans, including infants, children and the elderly, but will also cover compositions used as nutritional supplements whether provided in liquid or solid form. The antimicrobial compositions of the present invention have indeed been found to have a probiotic-like effect, enabling the growth of positive bacteria in the gut by reducing or inhibiting the growth of negative bacteria. Thus food compositions of the present invention may contribute to improved gut function.

### EXAMPLES

### Example 1

### Preparation of a Split Coconut Oil

A crude coconut oil from the Philippines, with 3% free fatty acids (FFA), was physically refined. The physical refining process consisted of an acid degumming step (citric acid), a bleaching step (with 1.5% acid activated bleaching earth and 2.5 kg/MT Norit SA Ultra activated carbon), and, finally, a deodorization step (240 C, 1% steam, 3 mbar). All conditions and filter aid used are according to industrial standards. The refined oil had a FFA level of <0.1% and a Lovibond red of <2.

The activated carbon treated oil was then hydrolysed using the Colgate-Emery process to obtain 98% free fatty acid purity, measured according to AOCS method Ca 5a-40 (lauric acid). The conditions of the Colgate-Emery process were according to industrial standards.

### Example 2

### Removal of PAHs Using Activated Carbon

Crude coconut oil containing 105 ppb of 4-PAH was treated with active carbon and physically refined under similar conditions as those described in Example 1. After the bleaching and activated carbon treatment step, the oil contained 3 ppb PAH and after the final deodorization step the PAH level was 0.3 ppb.

### Example 3

### Effects of Oil Source on Production Performance and Digestibility

### Experimental Design

A trial to evaluate the effect of different oil sources (soya oil and CNO-split obtained according to Example 1) was performed over a period of just over a month, split into two phases: Phase 1 (0-14 days), the starter phase, and Phase 2 (14-35 days), the grower phase. At 14 days, all birds were switched to a grower diet until 34 days of age. Feed and water were provided ad libitum.

### Birds and Housing

A total of 420 male Ross 308 day-old male chicks, derived from 57 week old broiler breeders, were purchased from a commercial hatchery. On arrival, the birds were randomly assigned to cages, with 17 birds per cage. After placement of the chicks, the total weight of all birds per cage was recorded to determine start weight of the chicks. The cages were evenly divided between two rooms (A and B). The cages in room A had average starting weights of 47.9 (+/−1.1) g/chick. The cages in room B has average starting weights of 44.5 (+/−1.3) g/chick.

Throughout the trial, birds were housed in individual broiler grower cages (100×110 cm) on litter (wood shavings). Each cage was equipped with two drinking cups with adjustable height. For the first 14 days, the feeder was inside the cage, and thereafter the feed was supplied via a feeder through the front of the cage.

Day length was set for 23 hours a day during the first 3 days, 20 hours a day from day 4 until day 7, and 18 hours a day during the remainder of the trial. Temperature, humidity and ventilation were computer controlled. Temperature was gradually decreased 2.5° C. per week, from 35° C. on the day of arrival to a final temperature of 20.5° C. at the end of the experiment (day 35). Relative humidity was set at 50%. The birds were spray-vaccinated against Newcastle Disease (Poulvac NDW-vaccine, Intervet, Boxmeer, NL) at 10 days of age.

### Experimental Diets

In advance of diet formulation, batches of wheat, corn and soybean meal (SBM) were reserved and wet chemically analysed for crude protein. Additionally, SBM was analysed for dry matter and K. Near Infrared Spectroscopy (NIRS) was used to predict crude ash, crude fat, crude fiber and moisture. SBM was also analysed for amino acid content.

Formulation of diets was based on the analysed nutrient content of the reserved raw materials. A basal diet was formulated, with soya oil as the only fat source. The other fat source (CNO-Split, prepared in accordance with Example 1) was added on a weight to weight basis, fully replacing the soya oil. The composition of the experimental diets is given in the following tables.

TABLE 1
Ingredients

| Ingredients, % | Starter diet | Grower diet |
|---|---|---|
| Corn BG1205 | 41.9 | 45.0 |
| Wheat BG1205 | 15.0 | 15.0 |
| Soybean meal >48% BG1205 | 33.7 | 30.6 |
| Fats/oils, Soya oil | 4.51 | 4.64 |
| Limestone | 1.7 | 1.4 |
| Monocalciumphosphate | 1.32 | 1.11 |
| Broiler premix 1% | 1.00 | 1.00 |
| Sodiumbicarbonate | 0.30 | 0.23 |
| Salt | 0.178 | 0.174 |
| L-Lysine HCl | 0.162 | 0.171 |
| DL-Methionine | 0.197 | 0.179 |
| L-Threonine | 0.010 | 0.011 |
| Total | 100.0 | 100.0 |

TABLE 2
Nutrients

| Nutrients, % | Starter diet | Grower diet |
|---|---|---|
| Crude protein | 21.5 | 20.4 |
| OIL (EE) | 7.1 | 7.3 |
| Crude fibre | 2.5 | 2.4 |
| Ash | 6.2 | 5.5 |
| DM | 88.7 | 88.6 |
| Calcium | 0.97 | 0.80 |
| Phosphor, total | 0.68 | 0.62 |
| Na | 0.16 | 0.14 |
| K | 0.88 | 0.83 |
| Cl | 0.18 | 0.18 |
| Dig.P broilers | 0.40 | 0.35 |
| aP broilers | 0.43 | 0.38 |
| dEB, meq | 243 | 223 |
| AME poultry, kcal | 3053 | 3120 |
| AME poultry (FS-R), kcal | 3068 | 3134 |
| AME broiler, kcal | 2850 | 2925 |
| LYS | 1.22 | 1.16 |
| MET | 0.52 | 0.49 |

TABLE 3
Analysis

| | Starter diets | | Grower diets | |
|---|---|---|---|---|
| | Control | CNO | Control | CNO |
| Calculated nutrients, % | | | | |
| Crude protein | 21.5 | 21.5 | 20.4 | 20.4 |
| Crude fat | 7.1 | 7.1 | 7.3 | 7.3 |
| Crude fibre | 2.5 | 2.5 | 2.4 | 2.4 |
| Dry matter | 88.7 | 88.7 | 88.6 | 88.6 |
| Ca | 0.97 | 0.97 | 0.80 | 0.80 |
| P | 0.68 | 0.68 | 0.62 | 0.62 |
| Analysed nutrients | | | | |
| Crude protein | 22.3 | 22.5 | 21.1 | 21.0 |
| Crude protein (NIRS) | 22.5 | 22.9 | 21.2 | 21.4 |
| Crude fat | 7.0 | 6.2 | 7.2 | 6.9 |
| (Soxhlet extraction) | | | | |
| Crude fat (NIRS) | 7.0 | 6.8 | 7.2 | 7.0 |
| Crude fibre (NIRS) | 2.3 | 1.9 | 2.4 | 1.9 |
| Moisture (NIRS) | 10.6 | 10.7 | 11.2 | 10.7 |
| Dry matter | 89.4 | 89.3 | 88.8 | 89.3 |
| Ca | 0.98 | 0.99 | 0.81 | 0.84 |
| P | 0.65 | 0.65 | 0.59 | 0.60 |
| % of expected | | | | |
| Crude protein | 104 | 105 | 103 | 103 |
| Crude fat | 99 | 88 | 98 | 94 |
| Crude fibre | 91 | 75 | 99 | 78 |
| Dry matter | 101 | 101 | 100 | 101 |
| Ca | 101 | 102 | 102 | 105 |
| P | 96 | 96 | 95 | 96 |

The diets were produced by Research Diet Services, the Netherlands. First a batch of basal diet without soya oil was produced. Then, to each batch the fat source (soya oil or CNO-split) was added. Starter diets were pelleted at 2.5 mm and grower diets at 3 mm with steam addition (app. 80° C.).

### Data Collection

Bird weights were recorded per cage at the start of the experiment (day 0) and individually at 7, 14, 21, 28 and 35 days of age. In addition, feed consumption for each cage was recorded on the same day the birds were weighed. Based on calculated body weight gain and feed consumption, feed to gain ratio (F:G) was calculated as kg of feed consumed/kg of weight gain. Total feed consumption per cage was corrected for mortality, culling and outliers (table 5). Finally, the European Poultry Index (EPI—De Herdt et all., 1999) was calculated using the following formula:

EPI=(final body weight (g)×(100%−mortality %))/((10×period in days)×overall FCR),

where FCR=Feed Conversion Ratio.

The EPI excluding mortality was calculated using the following formula:

EPI=(final body weight (g)×100)/((10×period in days)×overall FCR)

The results are set out in the following table.

TABLE 4
Body Weight and Feed Consumption

| | Soya oil | CNO-Split |
|---|---|---|
| Body Weight (BW) at 0 days, in g | 46 | 46 |
| BW 14 d, g | 553 | 543 |
| BW 34 d, g | 2353 | 2441 |
| Average Daily Gain (ADG) from 0-7 days, in g | 20.5 | 20.7 |
| ADG 0-14 d, g | 36.2 | 35.5 |
| ADG 0-34 d, g | 67.8 | 70.5 |
| ADG 14-34 d, g | 90.0 | 94.9 |
| Average Daily Feed Intake (ADFI) | 19.7 | 19.5 |
| from 0-7 days, in g | | |
| ADFI 0-14 d, g | 39.7 | 39.1 |
| ADFI 0-34 d, g | 97.5 | 98.7 |
| ADFI 14-34 d, g | 138 | 140 |
| Feed to Gain ratio (F:G) from 0-7 days, in g | 0.958 | 0.939 |
| F:G 0-14 d, g | 1.097 | 1.102 |
| F:G 0-34 d, g | 1.438 | 1.401 |
| F:G 14-34 d, g | 1.534 | 1.479 |
| F:G corrected for final BW | 1.432 | 1.369 |
| European Performance Index (EPI) | 458 | 493 |
| EPI, excluding mortality | 481 | 513 |

Table 5
Mortality, culling and Outliers

| Period | Mortality | Culling | Outliers* | Total** |
|---|---|---|---|---|
| d 0-14 | 2.0 | 0.2 | 2.2 | 4.4 |
| d 14-34 | 0.2 | 3.2 | 2.0 | 5.4 |
| d 0-34 | 2.2 | 3.4 | 4.2 | 9.8 |

*birds with lower weights than the [(average cage weight) − (2.5 × cage SD)] and female birds (d 34);
**calculated as a percentage of birds on d 0.

At day 35 of the experiment, all birds of each cage were successively weighted and killed by CO₂/O₂. Subsequently, the intestinal tract was removed and the content of the 2^{nd} half of the ileum (middle of ileum to the ileal-cecal-colon junction) was collected by gently squeezing using fingers. Samples were held on ice, frozen (−18° C.) and, afterwards, freeze-dried, ground (0.5 mm screen) and stored for analysis.

All samples were analysed for crude fat (AOCS Am 5-04), gross energy (bomb calorimetry) and acid insoluble ash (Schothorst Feed Research, the Netherlands) to determine digestibility.

### Results

Nutritional composition of the diets was in line with the expected values, except crude fat levels of the CNO-split starter diet which were lower than expected. This may be due to the MCFA content of the CNO-split for which a regular crude fat analysis is not suitable as heating of the sample during preparation may result in evaporation of the MCFA. During pelleting, heat is also used and this may also cause some evaporation.

Observed health status of the birds was good throughout the experiment. Mortality, including culling, reached 5.6%. No statistical differences in mortality were found between the different diets (i.e. soya oil vs. CNO-split).

Technical performance (mean body weight at d 34: 2,389 g) was in line with other trials carried out at the same facilities (mean body weight for 2011: 2,444 g).

During the starter period (0-14 d), there was no effect of fat source on average daily gain (ADG) or average daily feed intake (ADFI). However, F:G was affected by the fat source in the diet. From 0 to 7 days, CNO-split numerically improved F:G by 2.0% compared to soya oil. This may be related to the poor fat digestion of young birds, with MCFA being a more easily digested energy source.

In the grower period (14-34 d) ADG was significantly higher for birds fed CNO-split (+5.5%). Additionally, CNO-split significantly improved F:G (by 3.6%) compared to soya oil. During the entire period (0-34 d), similar trends as for the grower period were observed: CNO-split significantly improved ADG (by 3.9%) and overall period F:G (by 2.6%).

The only difference in excrecia quality was a tendency for the CNO-split to lower free water. This is thought to be related to an improved intestinal health.

Further permutations and embodiments of the present invention will be apparent to a person skilled in the art and are incorporated herein without further description.

1-14. (canceled)

15. A method of producing an antimicrobial composition, the method comprising the step of: splitting a refined lauric oil to obtain a composition comprising 90% or more, by weight, free fatty acids, and wherein the refined oil is an oil that has been brought into contact with activated carbon.

16. The method according to claim 15, wherein the refined oil is an oil that has been degummed, bleached and deodorized.

17. The method according to claim 15, wherein the splitting step is selected from chemical hydrolysis and enzymatic splitting.

18. The method according to claim 15, wherein the lauric oil is selected from coconut oil, palm kernel oil and mixtures thereof.

19. An antimicrobial composition comprising 90% or more, by weight, free fatty acids (FFAs), wherein the composition comprises, by weight:
0-5% C6 fatty acids;
1-15% C8 fatty acids;
1-15% C10 fatty acids; and
35-70% C12 fatty acids; and having
a total PAH level of 20 TEQ B[a]P or less.

20. The antimicrobial composition according to claim 19, wherein the composition has a total dioxin content no greater than 1.5 TEQ.

21. The antimicrobial composition according to claim 19, wherein the composition comprises 95% or more, FFAs by weight.

22. The antimicrobial composition according to claim 19, for use in food, feed and beverage compositions.

23. The antimicrobial composition according to claim 19, for use in preventing the growth of microbial agents and/or for improving gastro-intestinal health in animals.

24. The antimicrobial composition according to claim 19, for use in increasing feed efficiency and/or enhancing growth and/or reducing mortality in animals.

25. A feed comprising the composition according to claim 19, in an amount of 0.05-10% by weight.

26. The feed according to claim 25, suitable for use with calves, porcine animals, rabbits, poultry, domestic animals, and aquatic animals.
